(19) United States
(12) Patent Application Publication
(10) Pub. No.: US 2025/0281852 A1
(43) Pub. Date: Sep. 11, 2025

(54) SYSTEM AND METHOD FOR ELECTRICAL COALESCENCE SEPARATION

(71) Applicant: SAUDI ARABIAN OIL COMPANY, Dhahran (SA)

(72) Inventors: Abdulaziz ALSHALAWI, Dhahran (SA); Ali AL ABBAS, Dhahran (SA)

(73) Assignee: SAUDI ARABIAN OIL COMPANY, Dhahran (SA)

(21) Appl. No.: 18/596,360

(22) Filed: Mar. 5, 2024

(51) Int. Cl. B01D 17/06; B01D 17/04

(52) U.S. Cl. CPC B01D 17/06; B01D 17/045; B01D 2257/80; B01D 2259/818

(57) ABSTRACT

A system and method are disclosed relating to electrical coalescence separation. In some examples, a first electric field can be established in a first vessel that includes a first oil-water mixture received from an oil stream based on a first voltage. A second electric field can be established in a second vessel that includes a second oil-water mixture received from the oil stream based on a second voltage. The first electric field can be controlled based on the second voltage to control separation of water from oil in the first oil-water mixture in the first vessel.

### FIELD OF THE DISCLOSURE

This disclosure relates generally to oil separation, and more specifically, to electrical coalescence separation.

### BACKGROUND OF THE DISCLOSURE

Oil is extracted from a ground using oil wells. This can be done through primary recovery methods (natural pressure), secondary methods (water or gas injection to maintain pressure), or tertiary (enhanced oil recovery) methods involving chemicals, heat, or other techniques to improve flow. At an extraction site, there is often a site separation process implemented to remove a bulk of the gas and water mixed with the oil (crude oil). The oil, often still containing some gas and water, is transported to processing facilities. This can be done via pipelines, tanker trucks, or ships, depending on a location and infrastructure. At processing facilities, the oil can undergo an oil separation process. Desalters and dehydrators are used in the oil separation process to separate the oil from water and salt from the oil. Desalters are used to remove salt from the oil. Salt in the oil can lead to corrosion problems in refineries and needs to be removed before refining. Oil salt removal can be achieved by mixing the oil with water to dissolve the salts, which are then separated from the oil. Dehydrators are used to remove the water from the oil because excess water can cause problems such as pipeline corrosion, difficulty in processing, and transportation.

Various techniques can be used to remove water from the oil, such as chemical injection, gravity separation, and electric coalescence. Chemical injection uses chemicals, for example, demulsifiers, which are added to an oil-water mixture to breakdown emulsions to allow oil and water to separate. However, the stability of the water and oil emulsion makes separation difficult. Emulsions are stabilized by various substances present in the oil, which prevent the oil and water from separating. Gravity separation takes advantage of a density difference between oil and water to separate the oil from the water. Oil being less dense than water, floats to the top. In a gravity separator, the oil-water mixture is allowed to stand, and the crude oil naturally separates and rises above the water.

Water and emulsion stability impact or affect water separation and thus impact achieving or meeting crude oil specification. Crude oil specifications or “crude spec” refers to a set of criteria that oil must meet to be acceptable for transportation, storage, and refining. These criteria ensure that the oil can be safely and efficiently processed and refined into various products. Common specifications can include a measure of oil's density relative to water, sulfur content, water content, and salt content, for example. An emulsion in the context of oil extraction is a mixture where water droplets are dispersed within oil. Since oil and water are not naturally soluble in each other, they tend to form these emulsions. The stability of an emulsion refers to how long a dispersed phase (water droplets, in this case) remains distributed within a continuous phase (oil) without separating. High emulsion stability means that the water droplets do not easily coalesce and separate from the oil, leading to challenges in oil-water separation. Stable emulsions are more difficult to break, and thus complicate the oil separation process. This can increase costs and reduce the efficiency of oil processing. Various factors can affect emulsion stability, for example, such as a presence of natural surfactants in the oil (as these tend to stabilize the emulsion), physical conditions (e.g., temperature, pressure, and a method that is used for oil extraction), and/or mechanical agitations (e.g., processes like pumping and transporting can increase a stability of emulsions).

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a method can include causing a first electric field to be established in a first vessel that includes a first oil-water mixture received from an oil stream based on a first voltage, causing a second electric field to be established in a second vessel that includes a second oil-water mixture received from the oil stream based on a second voltage, and controlling the first electric field based on the second voltage to control separation of water from oil in the first oil-water mixture in the first vessel.

According to another embodiment, a system can include a main vessel configured to contain a first oil-water mixture received from an oil stream. A first electric field can be established in the main vessel to separate water from oil in the first oil-water mixture. The system can further include a test vessel configured to contain a second oil-water mixture received from the oil stream, and a controller configured to provide one or more test vessel operating commands to a test vessel power supply to cause the test vessel power supply to establish a second electric field in the test vessel to separate water from oil in the second oil-water mixture, and provide one or more main vessel operating commands to a main vessel power supply to cause the main vessel power supply to establish the first electric field in the test vessel to separate water from oil in the first oil-water mixture. The one or more main vessel operation commands can be provided based on a separation of the water from the oil in the second oil-water mixture.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of an electrical coalescence system.

FIG. 2 is an example of a coalescence control system.

FIG. 3 is an example of a power supply system.

FIG. 4 is an example of a method for controlling separation of water from oil in a oil-water mixture.

FIG. 5 is an example of a method of training a parameter prediction model.

FIG. 6 depicts an example computing environment that can be used to perform methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Electrical coalescence separation is a type of oil separation process used to remove water from oil, particularly in a treatment of emulsified water in oil. This process breaks down stable emulsions where water droplets are dispersed in oil. Electrical coalescence separation process starts with applying an electric field to an oil-water mixture, which is oil containing water (or traces of water, such as droplets). This field creates forces that act on water droplets dispersed in the oil. Specialized equipment, known as electrostatic coalescers or electrostatic treaters can be used to create the electric field. These coalescers have electrodes that generate the electric field. Under the influence of the electric field, water droplets start moving and colliding with each other. This process is known as coagulation. As these droplets collide, the droplets merge (coalesce) to form larger droplets. The water droplets prior to merging can be referred to as smaller water droplets and the droplets after coalescing can be referred to as larger water droplets. The electric field enhances this merging process and thus makes it more efficient than natural coalescence to separate water from the oil (the oil-water mixture). In some instances, chemicals (e.g., demulsifiers) are used alongside electrical coalescence separation. These chemicals reduce a surface tension and stabilize the emulsion, facilitating the coalescence of water droplets. The combination of chemical treatment and the electric field can further improve the efficiency of separating water from the oil. As a result of electrical coalescence, large water droplets are formed within the oil and a rate at which these large droplets are formed within the oil impact the efficiency at which water and oil are separated. The larger water droplets can be separated from the oil using gravitational forces. The large water droplets settle at a bottom of a separation vessel and can be drawn off.

To generate the electric field, a voltage is provided from a power supply and applied to electrodes, which are usually metal plates or rods placed inside a coalescer (vessel) that contains the oil-water mixture. When the power supply is turned on, a voltage difference is created between the electrodes. This voltage difference generates the electric field in a space around and between the electrodes and thus in the vessel. The configuration of the electrodes (e.g., shape, size, and arrangement) determines a distribution of the electric field within the coalescer. A uniform electric field is preferred so that the water droplets in the oil can be uniformly influenced. The power supply can be adjusted to provide the voltage to the electrodes with a particular amplitude (voltage level) and frequency. The strength of the electric field (related to the voltage level) and its frequency are initially set so that coalescence of water droplets is optimized. An amount of voltage (the voltage level) applied determines the strength of the electric field between the electrodes. Higher voltage typically results in a stronger electric field. The electric field exerts a force exerted on the water droplets based on the voltage level of the voltage provided by the power supply. The force has to be sufficient to overcome the barriers to coalescence such as surface tension and viscous forces within the oil-water mixture. The frequency of the voltage (voltage signal) can affect how the water droplets in the oil respond to the electric field. The frequency of the voltage influences the rate at which water droplets oscillate and collide, impacting their coalescence. Thus, the frequency of the voltage affects how the electric field changes over time, influence a movement and behavior of the smaller water water droplets within the oil-water mixture. Power supply settings (e.g., a voltage level and frequency) are chosen based on the properties of the oil-water mixture and the desired efficiency of separation. Once these settings are set (configured), the voltage level and frequency are fixed throughout the oil separation process. However, this limits separation of water and oil because a feed to a facility is not constant and changes frequently based on age, demand and field characteristics. Fixing frequency with changing oil parameters will not optimize the coalescence process. In some instances, based on prior experiences (or human experience) can be used to set the voltage level and frequency, but this may lead to a degradation in separation of oil and water, and thus fails to optimize the coalescence separation process.

Examples are disclosed herein in which a voltage level (amplitude) and/or frequency of a voltage for generating an electric field are adjusted dynamically during an electrical coalescence separation process so that an optimal amount of oil (crude oil) is produced (e.g., at a higher crude oil quality in comparison to existing electrical coalescence separation process used in an oil and/or gas industry for separating water and oil). According to the examples herein, an optimal amplitude and an optimal frequency can be determined and used to control an electric field applied to a oil-water mixture to improve an efficiency at which water is separated from oil in the oil-water mixture. The examples herein enable the water to be separated from the oil in the oil-water mixture at a greater efficiency than existing approaches because of the dynamic control of one or more electric field parameters (e.g., field strength) during the electrical coalescence separation process.

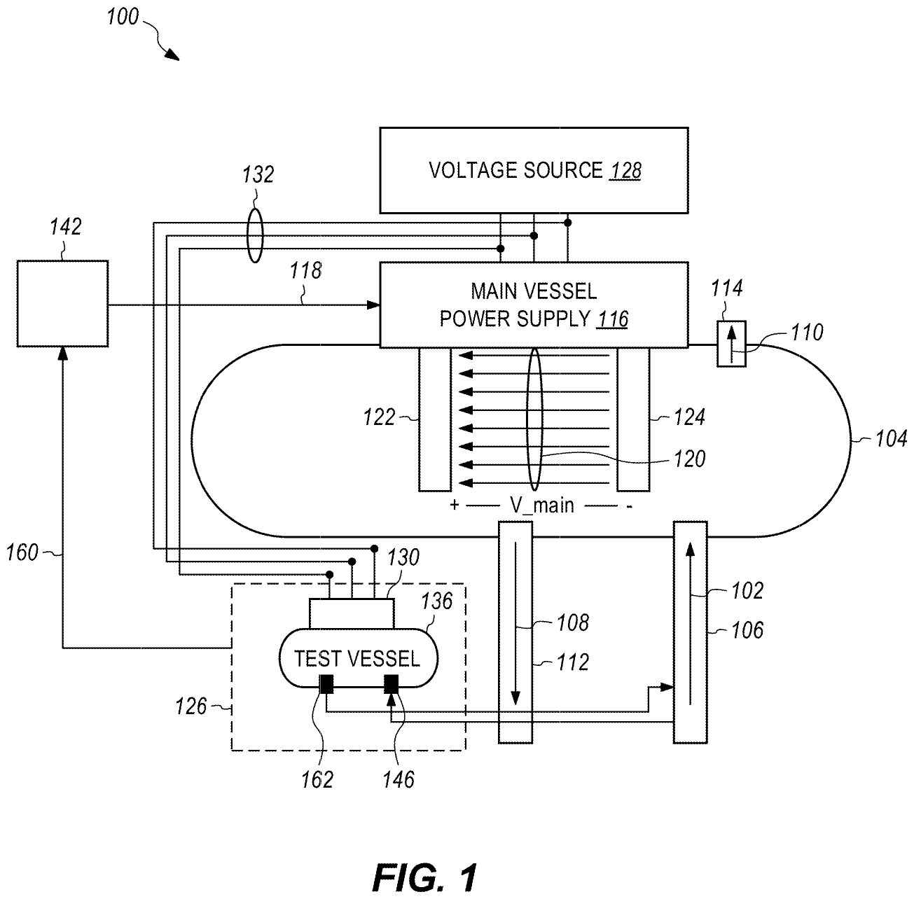

FIG. 1 is an example of an electrical coalescence system 100 that can be used to separate water from oil in an oil-water mixture from an oil stream 102. In some examples, the system 100 can be used in a dehydrator and/or desalter system. A water cut of oil is increasing to a challenging level, however the electrical coalescence is fixed in dehydrators and desalters. By using the system 100, water can be extracted or separated from the oil-water mixture at a greater efficiency than traditional electrical coalescence separation systems being used in a petroleum industry (e.g., oil and/or gas industry). The oil stream 102 can be provided to a main vessel 104 for electrical coalescence separation using an input tube 106, and in some examples be referred to as a first oil-water mixture. The main vessel 104 is a separation chamber or a vessel in which oil-water separation occurs using electricity. As disclosed herein, electrical coalescence separation can result in water droplets being separated from the oil-water mixture to produce water (or large water droplets) 108, and oil 110 that can be substantially free of the water 108. The large water droplets can settle at a bottom of the main vessel 104 and be drawn off and flow out of the main vessel 104 through an output tube 112. The oil 110 that has been extracted from the oil-water mixture can be provided downstream by an output tube 114 for further processing. For example, to separate the water 108 and the oil 110 in oil-water mixture, a main vessel power supply 116 can receive a one or more main vessel operating commands 118 specifying a amplitude for a voltage (or voltage signal) V_main and/or a frequency for that voltage for establishing a main vessel electric field 120 in the main vessel 104. The one or more main vessel operating commands 118 can be provided from a distributed control system (DCS) system interface (or screen) 132. In other examples, the one or more main vessel operating commands 118 can be provided by a controller (e.g., a controller 144, as shown in FIG. 1). The main vessel power supply 116 can provide the voltage V_main based on an input voltage 132 provided from a voltage source (or main power source) 128. The voltage source 128 can provide the input voltage 132 as a three-phase voltage (e.g., three separate alternating current (AC) waves). In some examples, the voltage source 128 is an electrical generator or a power grid.

To establish the main vessel electric field 120, the voltage V_main is applied across electrodes 122-124, which can be metal plates or rods placed inside the main vessel 104 that contains the oil-water mixture. In the example of FIG. 1 there are 2 electrodes 122-124 but there can be more than 2 in other examples. The electrodes 122-124 can be arranged to allow for establishment of the main vessel electric field 120. The main vessel electric field 120 is established due to a voltage difference between the electrodes 122-124 caused by the voltage V_main. The strength of the main vessel electric field 120 is based on the amplitude of the voltage V_main. The frequency of the voltage V_main can affect how water droplets (e.g., small water droplets) in the oil-water mixture respond to the main vessel electric field 120 and form larger water droplets to provide the water 108. The frequency of the voltage V_main affects how the main vessel electric field 120 changes over time, and influences a movement and behavior of the water droplets within the oil-water mixture.

The system 100 further includes a coalescence control system 126 that can be used for optimizing the main vessel electric field 120 in the main vessel 104 through control (or adjustment) of the amplitude and/or frequency of the voltage V_main that is used to establish the main vessel electric field 120 in the main vessel 104. The coalescence control system 126 can dynamically control the amplitude and/or frequency of the voltage V_main as content of the oil-water mixture changes.

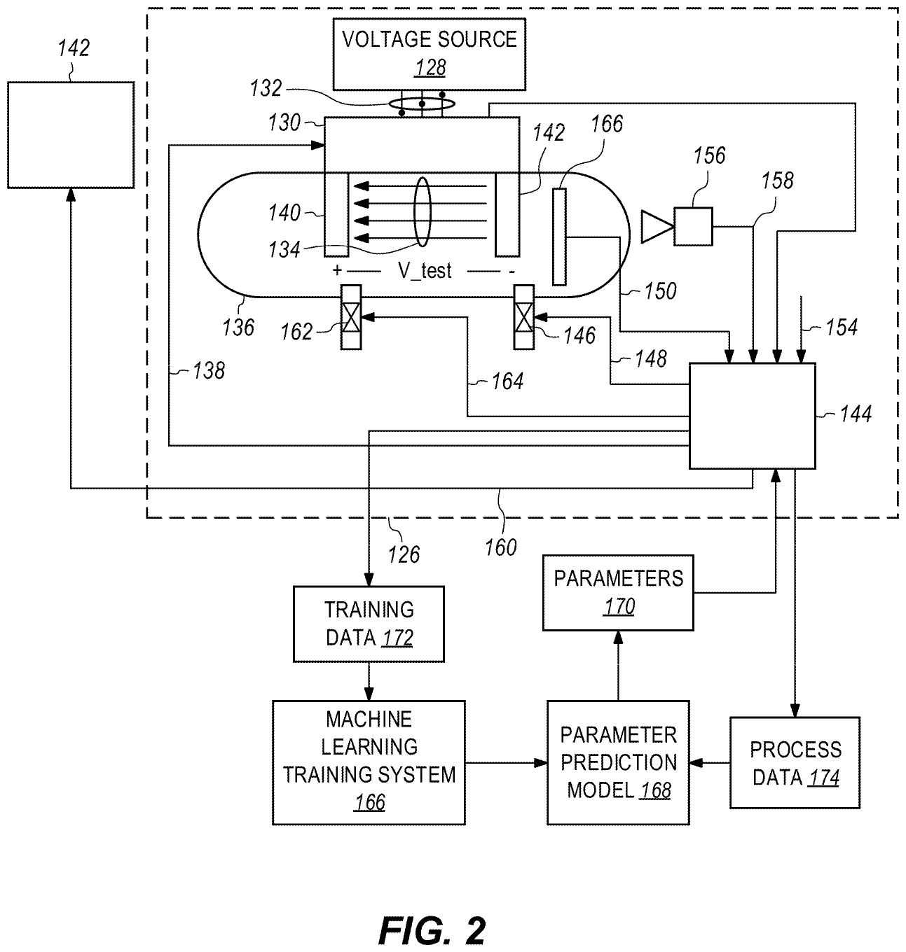

FIG. 2 is an example of the coalescence control system 126, as shown in FIG. 1. Thus, reference can be made to the example of FIG. 1 in the example of FIG. 2. The input voltage 132 from the voltage source 128 can be provided to a test vessel power supply 130 of the coalescence control system 126. The test vessel power supply 130 can establish a test vessel electric field 134 in a test vessel 136 of the coalescence control system 126, as shown in FIG. 2. For example, the test vessel power supply 130 can receive one or more test vessel operating commands 138 identifying and/or specifying test vessel voltage and frequency control parameters for a voltage V_test to be applied to the test vessel 136. The test vessel voltage and frequency control parameters can indicate a amplitude for a test vessel voltage (or voltage signal) V_test and/or a frequency for the voltage V_test. The voltage V_test can be used to establish the test vessel electric field 134 in the test vessel 136. To establish the test vessel electric field 134, the voltage V_test is applied across electrodes 140-142, which can be metal plates or rods placed inside the test vessel 136 based on one or more test vessel operating commands 138.

To optimize the main vessel electric field 120, the coalescence control system 126 includes a controller 144. The controller 144 can be implemented using one or more modules. The one or more modules can be in software and/or hardware form, or a combination thereof. In some examples, the controller 144 can be implemented as machine-readable instructions for execution on a computing platform (or system), for example, as disclosed herein. Thus in examples in which the controller 144 is implemented as machine-readable instructions, the controller 144 can be executed by a central processing unit (CPU), such as of the computer platform, as disclosed herein.

The controller 144 can coordinate operations (e.g., control valves, etc.) and/or make calculations and/or decisions to determine the amplitude and/or frequency of the voltage V_main that is needed so that the main vessel electric field 120 can be adjusted as contents of the oil-water mixture change over time in the main vessel 104. For example, a portion of the oil stream 102 can be provided into the test vessel 136, and in some instances can be referred to as an oil patch, or a second oil-water mixture. The incoming oil patch can be taken from a same oil stream that is going to the main vessel 104. For example, the oil patch (the second oil-water mixture) can be provided (or sent) to the test vessel 136 in response to the controller 144 causing an input valve 146 to open (e.g., by sending a valve open control signal 148) to provide the oil-water mixture from the oil stream 102 to the test vessel 136. A level detector (or device) 166 can be configured to monitor a level of the second oil-water mixture in the test vessel 136 and provide a test vessel level signal 150 to the controller 144. Another level detector (or device) (not shown in FIG. 1) can be configured to monitor a level of the first oil-water mixture in the main vessel 104 and provide a main vessel level signal 154 to the controller 144. The controller 144 can keep the input valve 146 open (e.g., in an open state) until an amount of the oil patch (the second oil-mixture) in the test vessel 136 is about equal to (or the same) as an amount of the oil-water mixture (the first oil mixture) in the main vessel 104. The controller 144 can evaluate the test vessel level signal 150 and the main vessel level signal 154 to determine when to close the input valve 146 (e.g., when the level of oil-water mixture is same in both of the test vessel 136 and the main vessel 104).

The controller 144 can implement (or execute) a voltage optimization method (or algorithm). For example, the controller 144 can begin the voltage optimization method by causing the test vessel power supply 130 to apply the voltage V_test at a high voltage (e.g., a high amplitude) and a low frequency The applying of the voltage V_test establishes the test vessel electric field 134 and a coalescence process in the test vessel 136. The high voltage enhances the movement and coalescence of water droplets in the oil, making the initial separation more effective. Starting with a low frequency allows for a more gentle oscillation of water droplets, minimizing a risk of creating too turbulent an environment, which can initially hinder the coalescence process in the test vessel 136.

The controller 144 can gradually adjust the amplitude of the voltage V_test until a breakdown level where a discharge current takes place, which can be used to identify an optimal voltage. Gradually adjusting the amplitude can refer to making a given or predefined increment or decrement in a voltage level of a voltage. In some examples, amplitude changes can be made in voltage steps. For instance, if the voltage V_test is adjusted in steps, the controller 144 can increase the voltage V_test by a certain number of volts or a percentage of a current voltage at each step. The breakdown level refers to a breakdown voltage at which electrical discharge (spark) is likely to occur or occurs. Thus, the breakdown level identifies a maximum amplitude of the voltage V_test, or an upper limit of safe voltage application in the test vessel 136. The breakdown level can be identified, for example, when an electrical discharge (spark) occurs. Oil from an electrical point of view is considered as dielectric material that prevent electrical current from flowing through the oil. If breakdown take place, it means that the oil becomes a conductor and it will allow electrical current to flow which is known as a short circuit and this can be detected using a mustimeter or relay. The relay can be set to trip short circuit current to avoid damaging equipment. Thus, in some examples, the system 126 can include the relay for detecting the breakdown level. The optimal voltage is considered to be just below a breakdown voltage, such as a previous voltage V_test (e.g., amplitude and/or frequency used) that was used before electrical discharge occurs. This is where the electric field is strong enough for effective coalescence without posing safety risks. Operating just below the breakdown voltage is optimal in processes like electrostatic coalescence. At this level, an electric field is strong enough to effectively promote the coalescence of water droplets in oil without risks associated with electrical discharges.

In some examples, controller 144 can gradually adjust the frequency of voltage V_test and monitor separation performance of the second water-oil mixture in the test vessel 136. In some examples, effects of frequency adjustment can be evaluated. For example, a basic sediment and water (BS&W) analyzer (not shown in FIG. 1) can be used to monitor (or measure) a water content in an outlet oil stream (e.g., provided by the outlet valve 162). The BS&W analyzer can provide a signal indicative of the water content in the oil from the outlet valve 162, which can be received by the controller 144. The controller 144 can adjust the frequency of the voltage V_test until the water content is within a defined or specified range, or is less than or equal to a water content threshold. In some examples, the controller 144 can vary the amplitude and the frequency of the voltage V_test to find a combination that yields a best separation efficiency for a specific oil stream (e.g., the oil stream 102). Different oil patches can have varying characteristics in their oil, including differences in viscosity, water content, and the nature of emulsions. As such, the optimal settings for voltage and frequency in the electrostatic coalescence process might differ from one oil patch to another. The controller 144 can be used to determine the optimal amplitude and/or frequency for each specific oil patch (and thus oil-water mixture) and use these parameters to set the amplitude and/or frequency of the voltage V_main that is applied to establish the main vessel electric field 120 in the main vessel 104 for the separation process therein. In some examples, a parameter change signal 160 specifying the optimal amplitude and/or frequency can be generated by the controller 144. In some examples, the controller 144 can be provided to the parameter change signal 160 to the main vessel power supply 116 to adjust (a current) amplitude and/or frequency of the voltage V_main. In other examples, the parameter change signal 160 can be provided to the DCS 142 and a user can approve a change or adjustment of amplitude and/or frequency of the voltage V_main and the DCS 142 can communicate the parameter change signal 160 to the main vessel power supply 116.

In some examples, an oil content monitor (or analyzer) 156 can be used to monitor the oil patch in the test vessel 136. In one example, the oil content analyzer 156 is an infrared spectrophotometer device. The oil content analyzer 156 can analyze a fluid mixture (the oil patch) to determine proportions of oil and water. The oil content analyzer 156 can output an oil content signal (or data) 158 indicating an amount of oil (e.g., an oil amount value) in the oil patch. The controller 144 can adjust the frequency and/or the voltage of voltage V_test based on the oil content of oil in the oil patch so that the separation process (electrostatic coalescence process) works more effectively for that oil patch. The controller 144 can compare the oil content signal 158 (the oil amount value) to an oil content threshold to determine whether there is a high amount of oil in the oil patch. If oil content signal 158 is greater than or equal to the content threshold this can indicate that oil content is high in the oil patch.

For example, if the separation process is not efficient enough (indicated by high oil content), the controller 144 can cause the amplitude of the voltage V_test to be increased to strengthen the test vessel electric field 134. This enhanced field can improve the coalescence of water droplets. If the separation is too aggressive or if there are signs of electrical discharges (indicating approaching the breakdown voltage), the amplitude of the voltage V_test can be lowered by the controller 144. The frequency of the voltage V_test can be increased when dealing with smaller water droplets in the oil patch, as it can enhance droplet movement and collision. A lower frequency can be more effective for larger droplets and can help in stabilizing the process.

For example, the controller 144 can be configured to implement an optimizer algorithm (method), also referred to herein as an optimizer, to find the frequency and/or the voltage for the voltage V_test. The optimizer can initially assign input and/or output parameters (e.g., as disclosed herein) either randomly or based on an initiation algorithm, then these parameters can be used for applying the voltage voltage V_test with an initial frequency and/or amplitude voltage. A coalescence can be monitored and based on the results (e.g., oil purity results), the optimizer can assign new parameters that is dependent on the initial parameters and results, and thus the optimizer is no longer assigning randomly. The controller 144 can be configured to adjust the frequency and/or the voltage of voltage V_test to find a maximum oil purity (e.g., by using an objective function) that is subjected to the following expressions:

$$\overline{f} \leq f \leq \underline{f} ; and \qquad ( 1 )$$

$$\overline{V} \leq V \leq \underline{V} . \qquad ( 2 )$$

For example, the controller 144 can measure (or receive data or a signal indicative of) the voltage V_test and the frequency of the voltage V_test and associate it to an output oil purity content. The controller 144 can be configured to implement an optimization process based on selected technique, for example, Differential Evolution (DE) or Bayesian Optimization (OP) in order to find a global maximum purity of the oil. The process can follow certain procedures to iterate input voltage and frequency to identify a solution that can provide a maximum oil purity. For the optimization process, the searching by the controller 144 can be bounded which means there need to be minimum and maximum values for the voltage V_test (e.g., identified as V and V̅ in expression (2)) and minimum and maximum values for the frequency of the voltage V_test (e.g., identified as f and f̅ in expression (2)).

Accordingly, the controller 144 can identify the optimal amplitude and/or frequency for the voltage V_main that is to be used based on the oil patch. The controller 144 can continuously monitor the oil patch in the test vessel 136 and adjust the amplitude and/or frequency of the voltage V_test based on the oil content signal 158 and the oil content threshold. The smaller a water droplet in the oil content the higher voltage frequency may be needed in order for it to coalesces. In some examples, the controller 144 can adjust the amplitude and/or frequency of the voltage V_test until the oil content signal 158 is below the oil content threshold. In some examples, referred to herein as a given example, the oil content analyzer 156 is omitted. In the given example, the oil patch (oil sample) is replaced by opening an outlet valve 162 to remove the oil sample and opening the input valve 146 to receive a new oil sample. For example, the oil patch can be released or emptied from the test vessel 136 in response to the controller 144 causing the outlet valve 162 to open (e.g., by sending a valve open control signal 164). The controller 144 can determine an updated optimal amplitude and/or frequency for the voltage V_main in a same or similar manner as disclosed herein.

In some examples, the controller 144 can store or record data associated with identifying or determining the optimal amplitude and/or frequency for the voltage V_main. The data can include a amplitude of the voltage V_test, a frequency of the voltage V_test, oil content from the oil content analyzer 156, oil level provided by the level detector 166, and a temperature of the oil using a thermometer (not shown in FIGS. 1-2) for a number of oil patches that been in the test vessel 136. The data can be referred to as training data 172. The training data 172 can be provided to a machine learning training system (or algorithm) 166 that can use the training data 172 to train a parameter prediction model 168. The parameter prediction model 168 can be used to predict parameters 170 (e.g., the amplitude and/or frequency for the of the voltage V_test). The parameter prediction model 168 can provide the predicted parameters 170 based on process data 174 from the controller 144. The processed data 174 can include voltage, frequency, current, oil purity, tap changer settings, AC & DC settings of an inverter, as disclosed herein, and oil level. In some examples, the processed data 174 can be referred to as input parameters herein. The parameter prediction model 168 can include a series of layers (e.g., input layer, hidden layers and an output layer), which can be formed from a set of neurons represented by weights and biases. For example, the parameter prediction model 168 can include a backpropagation neural network model.

Accordingly, the system 100 separates oil and water from a oil-water mixture (or the oil stream 102) at a improved or greater oil water separation efficiency than existing electrical coalescence separation system by adjusting the amplitude and frequency of the voltage being used to establish the main vessel electric field 120 in the main vessel 104. Using the system 100, a higher water quality and oil-water separation can be achieved, while increasing power efficiency and reducing power consumption and minimizing human intervention. Fixing voltage level for coalescence process is not efficient because sometime a voltage required is lower that what is applied which consumes more power. The system 100 can be used to optimize the applied voltage which will reduce power consumption, hence power efficiency will increase. Furthermore, the system 100 enables parameters (e.g., the amplitude and frequency of the voltage V_main) to be adjusted without the need to send a sample to a lab, which is time prohibitive. Thus, as optimal voltage and frequency of the voltage V_main may be inaccurate in early stages, the coalescence control system 124 allows for dynamic (or real-time) adjustment of the optimal voltage and frequency of the voltage V_main, such that an efficiency of oil-water separation is enhanced (improved). The examples herein can be used to enhance dehydrator and desalter vessels (e.g., the main vessel 104, as shown in FIG. 1) in a gas-oil separation plant (GASP).

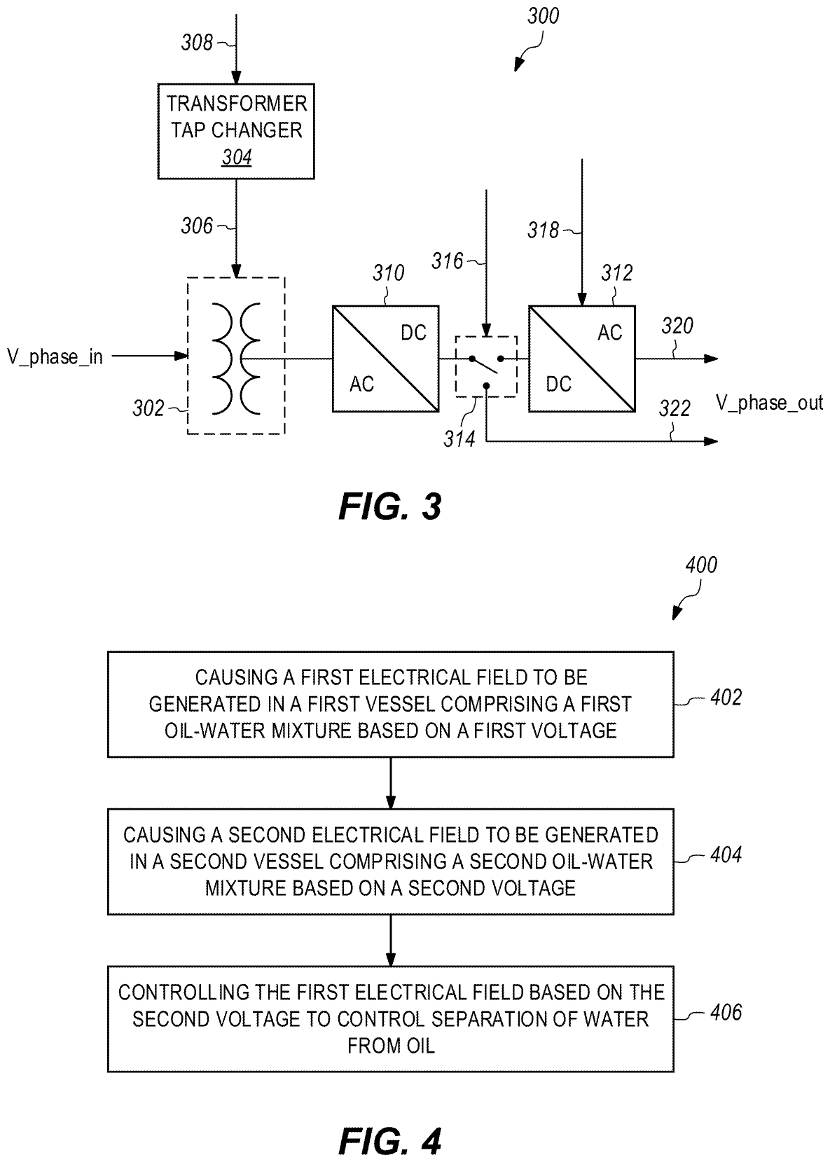

FIG. 3 is an example of a power supply system 300, such as the main vessel power supply 116 and/or the test vessel power supply 130, as shown in FIGS. 1-2. Thus, reference can be made to one or more examples of FIGS. 1-2 in the example of FIG. 3. The power supply system 300 can be used to generate a phase output voltage V_phase_out based on an input phase voltage V_phase_in of the input voltage 132 being provided from the voltage source 128. The input voltage 132 is a three-phase input voltage, such as a three-phase AC input voltage. For clarity and brevity purposes, a respective one of the AC-to-AC converters of the main vessel power supply 116 and/or the test vessel power supply 130 is shown in FIG. 3. Because the input voltage 132 is a three-phase voltage, the main vessel power supply 116 and/or the test vessel power supply 130 can include a respective AC-to-AC converter similar to the power supply system 300 for each voltage phase. The main vessel power supply 116 and/or the test vessel power supply 130 can output the voltage V_main or the voltage V_test, as shown in FIG. 1, which can also be a three-phase voltage.

In some examples, each leg or phase of the voltage V_main or the voltage V_test can be applied or supplied to a set of electrodes (e.g., two or more electrodes) for one of the main vessel 104 or the test vessel 136. Thus, there can be a number of sets of electrodes (e.g., three electrode sets) for each the main vessel 104 or the test vessel 136. Thus, in some examples, the set of electrodes 122-124 and 140-142, as show in respective FIGS. 1-2 can be representative of a number of sets of electrodes and the voltage V_main or the voltage V_test at one of the set of electrodes 122-124 and 140-142, as shown in FIGS. 1-2 corresponds to a phase output voltage of one of the voltage V_main or the voltage V_test. In other examples, each phase output voltage of the voltage V_main or the voltage V_test can be interleaved and applied across a respective set of electrodes for one of the main vessel 104 or the test vessel 136. For example, a switching mechanism can be used to alternatively connect each phase output voltage to the respective set of electrodes.

For example, the power supply system 300 includes a transformer 302. The transformer 302 can receive the input phase voltage V_phase_in and adjust an amplitude of the input phase voltage V_phase_in response to a transformer tap changer 304. The transformer tap changer 304 can regulate an output voltage V_transf_out. For example, the transformer tap changer 304 can adjust a turn ratio (e.g., a ratio of the number of turns in a primary winding to the number of turns in a secondary winding) of the transformer 302. By changing this ratio, the transformer tap changer 304 can regulate the output voltage V_transf_out. For example, the transformer tap changer 304 can change a point at which a tap is connected to a transformer winding to alter a number of turns in a winding. For example, the transformer tap changer 304 can issue one or more transformer connection commands 306 to physically change connections in a transformer winding (e.g., the primary and/or secondary windings). The transformer tap changer 304 can provide the one or more transformer connection commands 306 based on an amplitude control signal 308 from the controller 144. In some examples, the amplitude control signal 308 is one of the one or more main vessel operating commands 118 or the one or more test vessel operating commands 138, as shown in FIGS. 1-2, which is used for setting an amplitude of one of the voltage V_main or the voltage V_test (e.g., an output phase voltage).

The output voltage V_transf_out can be received by an alternating current to direct current (AC-to-DC) converter 310 to generate a DC output voltage V_DC_out. In examples in which the frequency of a corresponding output phase voltage of one of the phases of the voltage V_main or the voltage V_test is not set to zero, the DC output voltage V_DC_out can be provided to a DC-to-AC inverter 312. The DC-to-AC inverter 312 can provide the phase output voltage V_phase_out based on the DC output voltage V_DC_out. In some examples, a switch 314 can be positioned between the AC-to-DC converter 310 and the DC-to-AC inverter 312. The switch 314 can be controlled by a switch control signal 316. The switch control signal 316 can be provided by the controller 144.

For example, if the controller 144 determines that the frequency of the voltage V_main or the voltage V_test (e.g., of a corresponding output phase voltage) is not zero, the controller 144 can output the switch control signal 316. The switch control signal 316 can be used to establish or create an electrical connection (or path) between the AC-to-DC converter 310 and the DC-to-AC inverter 312 so that the DC output voltage V_DC_out can be established there between. The DC-to-AC inverter 312 can receive a frequency control signal 318 specifying a frequency of the phase output voltage V_phase_out. In some examples, the frequency control signal 318 is one of the one or more main vessel operating commands 118 or the one or more test vessel operating commands 138, as shown in FIGS. 1-2, which is used for setting the frequency of one of the voltage V_main or the voltage V_test (e.g., an output phase voltage).

In examples in which the DC-to-AC inverter 312 receives the frequency control signal 318, the phase output voltage V_phase_out can be outputted as an AC voltage signal 320. In examples in which the switch 314 does not receive the switch control signal 316, the phase output voltage V_phase_out can be outputted as a DC voltage signal 322. For example, if the controller 144 sets or determines that the frequency of the phase output voltage V_phase_out is zero, the DC-to-AC inverter 312 is bypassed (through the switch 314 not receiving the switch control signal 316) and the DC output voltage V_DC_out is provided as the phase output voltage V_phase_out (corresponding to the DC voltage signal 322).

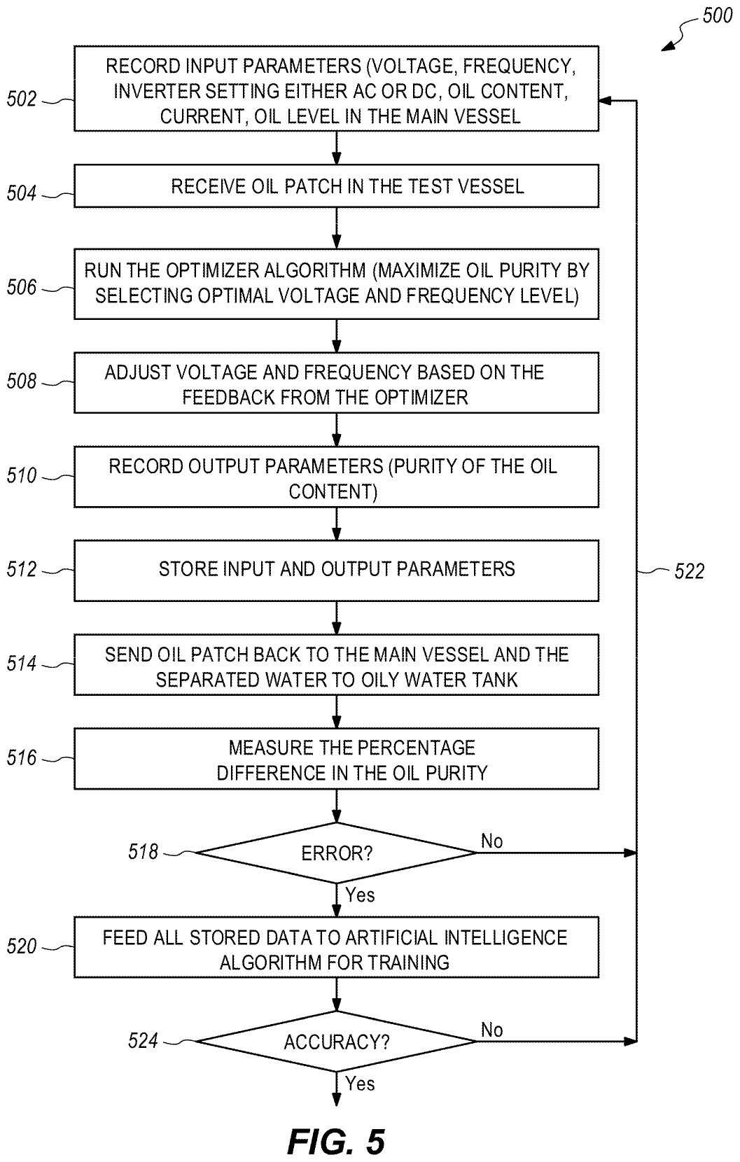

In view of the foregoing structural and functional features described above, an example method will be better appreciated with reference to FIGS. 4-5. While, for purposes of simplicity of explanation, the example methods of FIGS. 4-5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 4 is an example of a method 400 for controlling separation of water from oil in a oil-water mixture received from an oil stream. The method 400 can be implemented by the controller 144, as shown in FIG. 1. Thus, reference can be made to one or more examples of FIGS. 1-3 in the example of FIG. 4. The method 400 can begin at 402 by causing a first electric field (e.g., the main vessel electric field 120, as shown in FIG. 1) to be established in a first vessel (e.g., the main vessel 104, as shown in FIG. 1) comprising a first oil-water mixture received from an oil stream (e.g., the oil stream 102, as shown in FIG. 1) based on a first voltage (e.g., the voltage V_main, as shown in FIG. 1). At 404, a second electric field (e.g., test vessel electric field 134, as shown in FIG. 1) can be established in a second vessel (e.g., the test vessel 136, as shown in FIG. 2) comprising a second oil-water mixture received from the oil stream based on a second voltage (e.g., the voltage V_test, as shown in FIG. 2). At 406, the first electric field can be controlled based on the second voltage to control separation of water from oil in the first oil-water mixture in the first vessel.

FIG. 5 is an example of a method 500 for training the parameter prediction model 168, as shown in FIG. 2. Thus, reference can be made to one or more examples of FIGS. 1-4 in the example of FIG. 5. The method 500 can begin at 502 by recording or measuring input parameters, which can include an amplitude of the voltage V_main, a frequency of the voltage V_main, inverter settings (e.g., AC and/or DC settings), oil content of an oil patch (the oil-water mixture in the main vessel 104), current provided to the main vessel 104, and an oil level in the main vessel 104). The inverter settings can correspond to an amplitude for a voltage signal that is to be provided by the inverter. The amplitude can include an AC amplitude of the voltage signal is an AC signal, and a DC amplitude if the voltage signal is a DC signal. In some examples, the inverter is the AC-to-DC inverter 310 and/or the DC-to-AC inverter 318, as shown in FIG. 3. At 504, an oil patch in the test vessel 136 can be received or provided according to one or more examples disclosed herein. At 506, an optimizer algorithm (process), also known as an optimizer, in some examples, can be executed by the controller 144 to maximize oil purity by selecting or identifying optimal voltage (amplitude) and frequency values (levels) for the voltage V_test. At 508, the voltage and frequency of the voltage V_test can be adjusted based on a feedback from the optimizer. For example, the optimizer can initially assign all parameters either randomly or based on an initiation algorithm, then these parameters can be used to provide the voltage V_test with an initial voltage amplitude and/or frequency. Based on the results, the optimizer can assign new parameters that is dependent on the initial parameters and results, and thus is no longer assigning randomly.

At 510, one or more output parameters, such as purity of the oil content can be recorded. The recorded output and input parameters can be stored in the memory. At 512, the input and output parameters can be stored in the memory, such as of the controller 114, as shown in FIG. 2. In some examples, at 514, the oil patch can be send back to the main vessel 104 and the separated water to an oily water tank. For example, it may be preferable to send the oil patch back to the main vessel 104 if it has not separated efficiently (or sufficiently). The separated water (oily water) can be sent to an oily water tank for further processing. For example, the oily water tank can be used to recover a remaining amount of the oil that is left in the separated water so that the water meet specific requirements (such as minimal oil content) before it is disposed or used in one or more wells. At 516, a difference in oil purity can be measured in some instances as a percentage. The difference can between a recently received oil patch and a previously received oil patch following coalesce in the test vessel 136. For example, during an initial stage (optimization) input and output parameters can be recorded or captured. The input parameters can be used to train a machine learning model (e.g., the parameter prediction model 168) through use of supervised learning. Once the training is completed of the machine learning model and the model provides predictions at a certain or desired accuracy, the optimizer (algorithm) can be ignored by the controller 144 and the machine learning model can be used for tuning or adjusting the output parameters. In some examples, the parameter prediction model 168 can be implemented on the controller 144, in other examples, the parameter prediction model 168 can be implemented on a device or computing platform, such as disclosed herein. At 518, a difference determination is made. If the difference is less than an oil purity difference threshold at 518, the method 500 can proceed to step 520. Alternatively, if the difference is greater than the oil purity difference threshold, the method 500 can proceed (show as 522) to step 502.

At 520, the recorded input and output parameters (e.g., the training data 172, as shown in FIG. 2), at which the difference was less than the oil purity difference threshold, can be provided to the machine learning training system (or algorithm) 166, as shown in FIG. 2. For example, the parameter prediction model 168 can consist of an input layer, hidden layers and an output layer. Each layer can have neurons that are represented by weights and biases. During the training, these weights and/or biases can be tuned and once the training is finished these values can be fixed and can be used for future inputs (e.g., the process data 174, as shown in FIG. 2) to predict the outputs (e.g., the parameters 170, as shown in FIG. 2). The stored parameters can be used for training the parameter prediction model 168. At 522, an accuracy of the parameter prediction model 168 is verified based on the recorded parameters. If the accuracy of the parameter prediction model 168 is greater than or equal to an accuracy threshold, the method 500 can end (identified as “Yes” in the example of FIG. 5). Alternatively, if the accuracy of the parameter prediction model 168 is less than the accuracy threshold, the method 500 can proceed (shown as 522) back to step 502 for additional recorded parameters for training the parameter prediction model 168.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

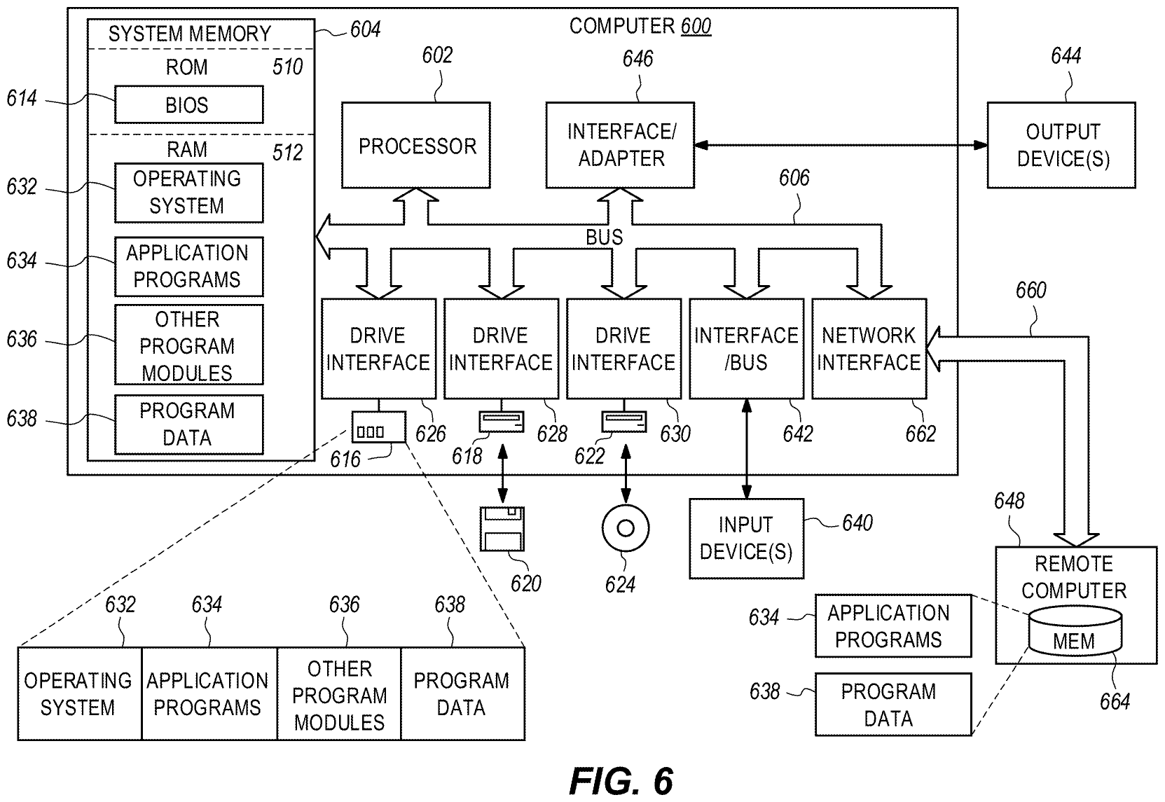

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 6. Thus, reference can be made to one or more examples of FIGS. 1-5 in the example of FIG. 6.

In this regard, FIG. 6 illustrates one example of a computer system (or computing platform) 600 that can be employed to execute one or more embodiments of the present disclosure. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient processing capabilities.

Computer system 600 includes processing unit 602, system memory 604, and system bus 606 that couples various system components, including the system memory 604, to processing unit 602. Dual microprocessors and other multi-processor architectures also can be used as processing unit 602. System bus 606 may be any of several types of bus structure including a memory bus or memory controller, a peripheral bus, and a local bus using any of a variety of bus architectures. System memory 604 includes read only memory (ROM) 610 and random access memory (RAM) 612. A basic input/output system (BIOS) 614 can reside in ROM 612 containing the basic routines that help to transfer information among elements within computer system 600.

Computer system 600 can include a hard disk drive 616, magnetic disk drive 618, e.g., to read from or write to removable disk 620, and an optical disk drive 622, e.g., for reading CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and computer-executable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 610, including operating system 532, one or more application programs 634, other program modules 636, and program data 638. In some examples, the application programs 634 can include one or more modules (or block diagrams), or systems, as shown and disclosed herein. Thus, in some examples, the application programs 634 can include the controller 144, as shown in FIG. 2.

A user may enter commands and information into computer system 600 through one or more input devices 640, such as a pointing device (e.g., a mouse, touch screen), keyboard, microphone, joystick, game pad, scanner, and the like. These and other input devices are often connected to processing unit 602 through a corresponding port interface 642 that is coupled to the system bus, but may be connected by other interfaces, such as a parallel port, serial port, or universal serial bus (USB). One or more output devices 644 (e.g., display, a monitor, printer, projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and a wide area network (WAN). When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, application programs 634 or program data 638 depicted relative to computer system 600, or portions thereof, may be stored in a remote memory storage device 654.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A method comprising:
causing a first electric field to be established in a first vessel comprising a first oil-water mixture received from an oil stream based on a first voltage;
causing a second electric field to be established in a second vessel comprising a second oil-water mixture received from the oil stream based on a second voltage; and
controlling the first electric field based on the second voltage to control separation of water from oil in the first oil-water mixture in the first vessel.

2. The method of claim 1, wherein the controlling comprises:
causing an amplitude and/or frequency of the second voltage to be changed to a first amplitude and/or first frequency to adjust the second electric field to control separation of water from oil in the second oil-water mixture in the second vessel; and
causing the first electric field to be adjusted based on the first amplitude and/or first frequency of the second voltage.

3. The method of claim 2, wherein causing the first electric field to be adjusted in the first vessel comprises causing an amplitude and/or frequency of the first voltage to be changed so that the amplitude and/or frequency of the first voltage matches the first amplitude and/or first frequency of the second voltage to change a rate at which the water is separated from the oil in the first oil-water mixture.

4. The method of claim 3, further comprising:
receiving an oil content signal indicating an amount of oil in the second oil-water mixture; and
causing the amplitude and/or frequency of the second voltage to be changed to the first amplitude and/or frequency based on the oil content signal.

5. The method of claim 1, further comprising:
causing the second oil-water mixture to be removed from the second vessel;
causing a third oil-water mixture to be received from the oil stream at the second vessel; and
causing a third electric field to be established in the second vessel, when the third oil-water mixture is present in the second vessel, based on the second voltage.

6. The method of claim 5, further comprising:
causing an amplitude and/or frequency of the second voltage to be changed to a first amplitude and/or first frequency to adjust the third electric field; and
causing the first electric field to be adjusted in the first vessel based on the first amplitude and/or first frequency of the second voltage.

7. The method of claim 2, wherein the controlling comprises one of:
providing an amplitude control signal to cause an amplitude of the first voltage to be adjusted to match the first amplitude of the second voltage; and
providing a frequency control signal to cause a frequency of the first voltage to be adjusted to match the first frequency of the second voltage.

8. The method of claim 1, wherein the controlling comprises receiving approval from a user for using the second voltage to control the first electric field for the first vessel.

9. A system comprising:
a main vessel configured to contain a first oil-water mixture received from an oil stream, wherein a first electric field is established in the main vessel to separate water from oil in the first oil-water mixture;
a test vessel configured to contain a second oil-water mixture received from the oil stream; and
a controller configured to:
provide one or more test vessel operating commands to a test vessel power supply to cause the test vessel power supply to establish a second electric field in the test vessel to separate water from oil in the second oil-water mixture; and
provide one or more main vessel operating commands to a main vessel power supply to cause the main vessel power supply to establish the first electric field in the test vessel to separate water from oil in the first oil-water mixture, the one or more main vessel operation commands being provided based on a separation of the water from the oil in the second oil-water mixture.

10. The system of claim 9, wherein the one or more test vessel operating commands comprises a command to adjust an amplitude and/or frequency of a test vessel voltage generated by the test vessel power supply for establishing the second electric field.

11. The system of claim 10, wherein the one or more main vessel operating commands comprises a command to adjust one of an amplitude and frequency of a main vessel voltage generated by the main vessel power supply for establishing the first electric field.

12. The system of claim 11, wherein the amplitude and/or frequency of the main vessel voltage is adjusted to match the amplitude and/or frequency of the test vessel voltage.

13. The system of claim 1, wherein the controller is further configured to receive an oil content signal indicating an amount of oil in the second oil-water mixture, wherein the amplitude and/or frequency of the main vessel voltage is further adjusted based on the amount of oil in the second oil-water mixture.

14. The system of claim 10, wherein the main vessel power supply comprises a transformer and a transformer tap changer for changing an amplitude of a voltage outputted by the transformer based on a voltage command of the one or more main vessel operating commands, the voltage being outputted by the transformer being used to generate a main vessel voltage for adjusting the first electric field.

15. The system of claim 14, wherein the main vessel power supply further comprises an inverter and a frequency of the inverter being set based on a frequency command of the one or more main vessel operating commands, such that that main vessel voltage is outputted at a similar frequency as test vessel voltage used to provide the second electric field.
